(19) United States
(12) Patent Application Publication
(10) Pub. No.: US 2025/0231740 A1
(43) Pub. Date: Jul. 17, 2025

(54) SYSTEMS AND METHODS FOR CONFIGURABLE ADDER CIRCUIT

(71) Applicant: Taiwan Semiconductor Manufacturing Company, Ltd., Hsinchu (TW)

(72) Inventors: Haruki Mori, Hsinchu City (TW); Hidehiro Fujiwara, Hsinchu City (TW); Je-Min Hung

(73) Assignee: Taiwan Semiconductor Manufacturing Company, Ltd., Hsinchu (TW)

(21) Appl. No.: 18/642,357

(22) Filed: Apr. 22, 2024

Related U.S. Application Data
(60) Provisional application No. 63/621,237, filed on Jan. 16, 2024.

(51) Int. Cl. G06F 7/501

(52) U.S. Cl. CPC G06F 7/501

(57) ABSTRACT

A system includes a computation circuit, a memory array operably coupled with the computation circuit, and a controller configured to input a plurality of input data bits to the computation circuit, identify a number of accumulation associated with the plurality of input data bits, based on the number of accumulation, determine whether to enable or disable at least one component of the computation circuit, and based on a determination to enable or disable, generate a control signal to enable or disable the at least one component of the computation circuit.

### CROSS-REFERENCE TO RELATED APPLICATION

This application claims priority to and the benefit of U.S. Provisional Application No. 63/621,237, filed Jan. 16, 2024, entitled “Configurable Adder Tree For CIM Macro,” which is incorporated herein by reference in its entirety for all purposes.

### BACKGROUND

Computer artificial intelligence (AI) has been built on machine learning, for example, using deep learning techniques. With machine learning, a computing system organized as a neural network computes a statistical likelihood of a match of input data with prior computed data. A neural network refers to a number of interconnected processing nodes that enable the analysis of data to compare an input to “trained” data. Trained data refers to computational analysis of properties of known data to develop models to use to compare input data. An example of an application of AI and data training is found in object recognition, where a system analyzes the properties of many (e.g., thousands or more) of images to determine patterns that can be used to perform statistical analysis to identify an input object.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a block diagram of a data computation circuit, in accordance with some embodiments of the present disclosure.

FIG. 2 illustrates a block diagram of a portion (hereinafter referred to as a “configurable circuit”) of an example data computation circuit, in accordance with some embodiments of the present disclosure.

FIG. 3 illustrates a schematic diagram of an example configurable circuit, in accordance with some embodiments of the present disclosure.

FIG. 4A illustrates a schematic diagram of an example adder circuit, in accordance with some embodiments of the present disclosure.

FIG. 4B tabulates example status of components in the adder circuit shown in FIG. 4A for different numbers of accumulations, in accordance with some embodiments of the present disclosure.

FIG. 5 illustrates an example plot of signals associated with the adder circuit shown in FIG. 4A, in accordance with some embodiments of the present disclosure.

FIG. 6A illustrates an example logic circuit that can be coupled with the configurable circuit shown in FIG. 2, in accordance with some embodiments of the present disclosure.

FIG. 6B tabulates example modes with respect to the numbers of accumulations and corresponding control signals, in accordance with some embodiments of the present disclosure.

FIG. 6C illustrates example logic components that can be coupled with the configurable circuit shown in FIG. 2, in accordance with some embodiments of the present disclosure.

FIG. 7A illustrates a block diagram of an example configurable circuit, in accordance with some embodiments of the present disclosure.

FIG. 7B tabulates example control signals and corresponding outputs of the MUX shown in FIG. 7A, in accordance with some embodiments of the present disclosure.

FIG. 7C illustrates a block diagram of the adder circuit shown in FIG. 7A, in accordance with some embodiments of the present disclosure.

FIG. 7D tabulates example bit numbers of the different adders shown in FIG. 7A, in accordance with some embodiments of the present disclosure.

FIG. 8 illustrates an example selecting circuit that can be coupled with the configurable circuit shown in FIG. 2, in accordance with some embodiments of the present disclosure.

FIG. 9A illustrates an example circuit that can be coupled with the configurable circuit shown in FIG. 2, in accordance with some embodiments of the present disclosure.

FIG. 9B illustrates an example plot of signals associated with the circuit shown in FIG. 9A in accordance with some embodiments of the present disclosure.

FIG. 10 illustrates a flow chart of an example method of operating a configurable circuit, in accordance with various embodiments.

FIG. 11 illustrates a flow chart of an example method of operating a configurable circuit, in accordance with various embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Neural networks compute “weights” to perform computation on new data (an input data “word”). Neural networks use multiple layers of computational nodes, where deeper layers perform computations based on results of computations performed by higher layers. Machine learning currently relies on the computation of dot-products and absolute difference of vectors, typically computed with multiply-accumulate (MAC) operations performed on the parameters, input data and weights. The computation of large and deep neural networks typically involves so many data elements, and thus it is not practical to store them in processor cache. Accordingly, these data elements are usually stored in a memory.

Thus, machine learning is very computationally intensive with the computation and comparison of many different data elements. The computation of operations within a processor is orders of magnitude faster than the transfer of data elements between the processor and main memory resources. Placing all the data elements closer to the processor in caches is prohibitively expensive for the great majority of practical systems due to the memory sizes needed to store the data elements. Thus, the transfer of data elements becomes a major bottleneck for AI computations. As the data sets increase, the time and power/energy a computing system uses for moving data elements around can end up being multiples of the time and power used to actually perform computations.

In this regard, computing-in-memory (CIM) circuits have been proposed to perform such MAC operations. A CIM circuit conducts data processing in situ within a suitable memory circuit. The CIM circuit suppresses the latency for data/program fetch and output results upload in corresponding memory (e.g. a memory array), thus solving the memory (or von Neumann) bottleneck of conventional computers. Another key advantage of the CIM circuit is the high computing parallelism, thanks to the specific architecture of the memory array, where computation can take place along several current paths at the same time. The CIM circuit also benefits from the high density of multiple memory arrays with computational devices, which generally feature excellent scalability and the capability of 3D integration. As a non-limiting example, the CIM circuit targeted for various machine learning applications can perform the MAC operations locally within the memory (i.e., without having to send data elements to a host processor) to enable higher throughput dot-product of neuron activation and weight matrices, while still providing higher performance and lower energy compared to computation by the host processor.

The data elements, processed by the CIM circuit, have various types or forms, such as integers number and floating point numbers. A floating point number is typically represented by a sign portion, an exponent portion, and a significand (mantissa) portion that consists of the significant digits of the number. For example, a floating point number format specified by the Institute of Electrical and Electronics Engineers (IEE®) is thirty-two bits in size and includes twenty-three mantissa bits, eight exponent bits, and one sign bit. Another floating point number format is sixteen bits in size, which includes ten mantissa bits, five exponent bits, and one sign bit.

In machine learning applications, the CIM circuit is frequently configured to process dot product multiplications based on performing MAC operations on a large number of data elements (e.g., an input word vector and a weight matrix), which may each be in the form of floating point numbers, and then process addition (or accumulation) of such dot products.

With such an approach, adder circuits configured for a fixed number of accumulation can face low utilization when processing a different number of accumulation in given neural network layers. For example, when an adder circuit (or an accumulator, an adder tree) of the CIM circuit is designed for 64 accumulation, the utilization of the CIM circuit is reduced when processing a low number of accumulation (e.g., 8, 16, 32, etc.).

The present disclosure provides various embodiments of a CIM circuit. The CIM circuit disclosed herein can include a configurable adder circuit to have a configurable number of accumulation (e.g., configurable between various numbers of accumulation). For example, when the CIM circuit can support up to 64 accumulation, the CIM circuit can support 2 sets of 32 accumulation, 4 sets of 16 accumulation, and 8 sets of 8 accumulation. The disclosed CIM circuit can include a feature or a component for detecting a number of accumulation and then configuring an adder circuit according to the detected number of accumulation, thereby improving the CIM utilization and taking preventive measures for the multipliers to reduce computation/calculation resource/power usage for the MAC operation. In one aspect, the disclosed CIM circuit can input a plurality of input data bits to the computation circuit, identify a number of accumulation associated with the plurality of input data bits, based on the number of accumulation, determine whether to enable or disable at least one component of the computation circuit, and based on a determination to enable or disable, generate a control signal to enable or disable the at least one component of the computation circuit. In some embodiments, the disclosed CIM circuit can include a first component configured to receive a plurality of input data bits and provide a first output in response to a control signal, a second component configured to receive the first output from the first component and provide a second output in response to the control signal including a first logic value, and a multiplexer configured to output the first output in response to the control signal including a second logic value, and configured to output the second output in response to the control signal including the first logic value.

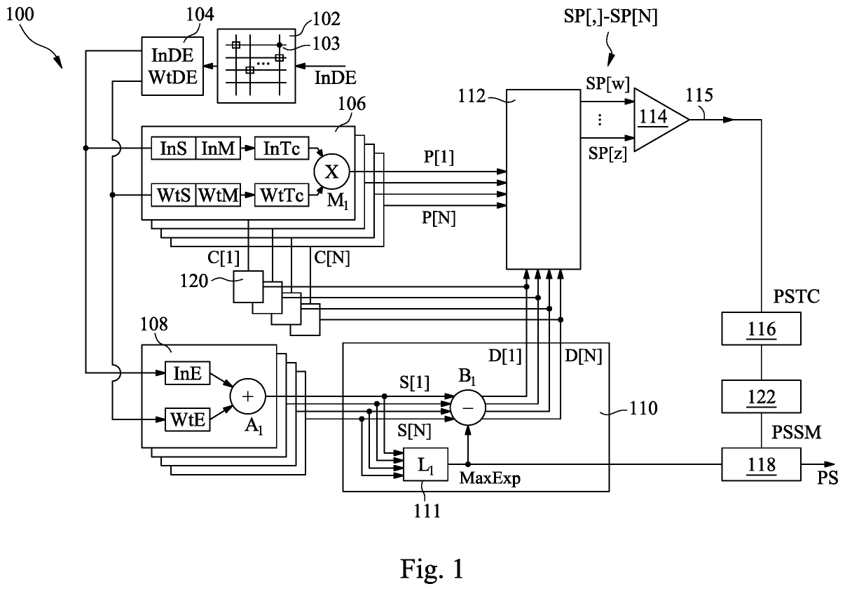

FIG. 1 illustrates a block diagram of a data computation circuit 100, in accordance with some embodiments of the present disclosure. In the illustrated embodiment depicted in FIG. 1, the data computation circuit 100, also referred to as (e.g., CIM) circuit 100 or memory circuit 100, includes various components collectively configured to perform in-memory computations (e.g., multiply-accumulate (MAC) operations) on an input word vector and a weight matrix. The input word vector can include a plural number (N) of input data elements InDE, and the weight matrix can include a plural number (Nd) of weight data elements WtDE. In various embodiments, each of the input data elements InDE and the weight data elements WtDE may include a floating point number.

As shown, the circuit 100 includes a memory circuit 102, an input circuit 104, a number of multiplier circuits 106, a number of summing circuits 108, a difference circuit 110 (e.g., sometimes referred to as a subtractor circuit 110), a shifting circuit 112, an adder circuit (or adder tree) 114, a first converter 116, a second converter 118, a control circuit 120, and an output multiplexer (MUX) 122. In some embodiments, the number of multiplier circuits 106 may correspond to the number of summing circuits 108 or the number of control circuit 120. For example, the circuit 100 may include N (the number of weight/input data elements WtDE/InDE) multiplier circuits 106, N (the number of weight/input data elements WtDE/InDE) summing circuits 108, and N (the number of weight/input data elements WtDE/InDE) control circuit 120. It should be appreciated that the block diagram of the circuit depicted in FIG. 1 is simplified, and thus, the circuit 100 can include any of various other components while remaining within the scope of the present disclosure.

The memory circuit 102 may include one or more memory arrays and one or more corresponding circuits. The memory arrays are each a storage device including a number of storage elements 103, each of the storage elements 103 including an electrical, electromechanical, electromagnetic, or other device configured to store one or more data elements, each data element including one or more data bits represented by logical states. In some embodiments, a logical state corresponds to a voltage level of an electrical charge stored in a portion or all of a storage element 103. In some embodiments, a logical state corresponds to a physical property, e.g., a resistance or magnetic orientation, of a portion or all of a storage element 103.

In some embodiments, the storage element 103 includes one or more static random-access memory (SRAM) cells. In various embodiments, an SRAM cell includes a number of transistors, e.g., a five-transistor (5T) SRAM cell, a six-transistor (6T) SRAM cell, an eight-transistor (8T) SRAM cell, a nine-transistor (9T) SRAM cell, etc. In some embodiments, an SRAM cell includes a multi-track SRAM cell. In some embodiments, an SRAM cell includes a length at least two times greater than a width.

In some embodiments, the storage element 103 includes one or more dynamic random-access memory (DRAM) cells, resistive random-access memory (RRAM) cells, magnetoresistive random-access memory (MRAM) cells, ferroelectric random-access memory (FeRAM) cells, NOR flash cells, NAND flash cells, conductive-bridging random-access memory (CBRAM) cells, data registers, non-volatile memory (NVM) cells, 3D NVM cells, or other memory cell types capable of storing bit data.

In addition to the memory array(s), the memory circuit 102 can include a number of circuits to access or otherwise control the memory arrays. For example, the memory circuit 102 may include a number of (e.g., word line) drivers operatively coupled to the memory arrays. The drivers can apply signals (e.g., voltages) to the corresponding storage elements 103 to allow those storage elements 103 to be accessed (e.g., programmed, read, etc.). For another example, the memory circuit 102 may include a number of programming circuits and/or read circuits that are operatively coupled to the memory arrays.

The memory arrays of the memory circuit 102 are each configured to store a number of the weight data elements WtDE. In some embodiments, the programming circuits may write the weight data elements WtDE into corresponding storage elements 103 of the memory arrays, respectively, while the reading circuit may read bits written into the storage elements 103, so as to verify or otherwise test whether the written weight data elements WtDE are correct. The drivers of the memory circuit 102 can include or be operatively coupled to a number of input activation latches that are configured to receive and temporarily store the input data elements InDE. In some other embodiments, such input activation latches may be part of the input circuit 104, which can further include a number of buffers that are configured to temporarily store the weight data elements WtDE retrieved from the memory arrays of the memory circuit 102. As such, the input circuit 104 can receive the input data elements InDE and the weight data elements WtDE.

In various embodiments of the present disclosure, the input word vector (including, e.g., the input data elements InDE) and the weight matrix (including, e.g., the weight data elements WtDE), on which the circuit 100 is configured to perform MAC operations, each include a number of floating point numbers. As such, each of the data elements InDE and weight data elements WtDE includes a sign bit, a plural number of exponent bits, and a plural number of mantissa bits (sometimes referred to as fraction bits).

For example, each of the data elements InDE and weight data elements WtDE has a BF16 format, also referred to as a bfloat format or brain floating-point format in some embodiments, in which a first bit represents a sign of a floating-point number, a subsequent eight bits represent an exponent of the floating-point number, and the final seven bits represent the mantissa, or fraction, of the floating-point number. Because the mantissa is configured to start with a non-zero value, the final seven bits of each stored data element represent an eight-bit mantissa having a first, most significant bit (MSB) equal to one.

In some embodiments, each of the data elements InDE and the weight data elements WtDE has a FP16 format, also referred to as a half precision format, in which a first bit represents a sign of a floating-point number, a subsequent five bits represent an exponent of the floating-point number, and the final ten bits represent the mantissa, or fraction, of the floating-point number. In this case, the final ten bits of each stored data element represent an eleven-bit mantissa having a first MSB equal to one. In some other embodiments, each of the data elements InDE and the weight data elements WtDE has a floating-point format other than a BF16 or FP16 format, e.g., another 16-bit format, a 32-bit, 64-bit, 128-bit, or 256-bit format, or a 40-bit or 80-bit extended precision format. The sign and mantissa of a data element representing a floating-point number are collectively referred to as a signed mantissa of the floating-point number. The MSB of a mantissa is referred to as a hidden bit or hidden MSB.

Referring still to FIG. 1, the input circuit 104 is configured to output entireties of each data element of data elements InDE and WtDE to each of the multiplier circuits 106 and the summing circuits 108. In some embodiments, the input circuit 104 is configured to output the signed mantissa of each data element to the multiplier circuit 106 and the exponent of each data element to the summing circuit 108, which will be described as follows.

The multiplier circuits 106 are each an electronic circuit, e.g., an integrated circuit (IC), configured to receive, e.g., from the input circuit 104, a sign bit InS and a mantissa InM (collectively a signed mantissa InS/InM) of each of the N data elements InDE, and a sign bit WtS and a mantissa WtM (collectively a signed mantissa WtS/WtM) of each of the N data elements WtDE. The summing circuits 108 are each an electronic circuit, e.g., an IC, configured to receive, e.g., from the input circuit 104, an exponent InE of each of the N data elements InDE, and an exponent WtE of each of the N data elements WtDE.

The multiplier circuits 106 may each include one or more data registers (not shown) configured to receive the instances of signed mantissas InS/InM and WtS/WtM. In the embodiment depicted in FIG. 1, the multiplier circuit 106 is configured to receive the instances of signed mantissas InS/InM and WtS/WtM corresponding to data elements InDE and WtDE. In some other embodiments, the multiplier circuit 106 includes the one or more data registers configured to receive the instances of signed mantissas InS/InM and/or WtS/WtM including the hidden MSBs. In some embodiments, the multiplier circuit 106 includes the one or more data registers configured to add the hidden MSBs to the received instances of signed mantissas InS/InM and/or WtS/WtM.

The multiplier circuit 106 may include logic circuitry (not shown) configured to, in operation, reformat each instance of signed mantissa InS/InM to a two's complement mantissa InTC, also referred to as reformatted mantissa InTC, and to reformat each instance of signed mantissa WtS/WtM to a two's complement mantissa WtTC, also referred to as reformatted mantissa WtTC. Reformatted mantissa InTC has a same number of bits as signed mantissa InS/InM, and reformatted mantissa WtTC has a same number of bits as signed mantissa WtS/WtM.

The multiplier circuit 106 may include one or more logic gates M1 configured to, in operation, multiply some or all of the instances of reformatted mantissas InTC with some or all of the instances of reformatted mantissas WtTC, thereby generating N products, e.g., P[1] to P[N]. In various embodiments, the one or more logic gates M1 include one or more AND or NOR gates or other circuits suitable for performing some or all of a multiplication operation. The one or more logic gates M1 are configured to, in operation, generate each of the products P[1] to P[N] as a two's complement data element including a number of bits equal to twice the number of bits of reformatted mantissas InTC and WtTC minus one. The one or more logic gates M1 may be referred to as a multiplier configured to multiply some or all of the instances of reformatted mantissas InTC with some or all of the instances of reformatted mantissas WtTC. In some cases, the multiplier (e.g., the one or more logic gates M1) can receive the signed mantissa InS/InM or the signed mantissa WtS/WtM for the multiplication.

The multiplier circuits 106 are configured to, in operation, generate the number N of products P[1] to P[N]. For example, the multiplier circuits 106 can generate the number N of products P[1]-P[N] equal to sixteen. In some other embodiments, the multiplier circuits 106 can generate the number N of products P[1]-P[N] fewer or greater than sixteen.

In some embodiments, e.g., those in which data elements InDE and WtDE have the BF16 format, the multiplier circuit 106 is configured to generate each of the products P[1]-P[N] having a total of 17 bits based on each of signed mantissas InS/InM and WtS/WtM and reformatted mantissas InTC and WtTC having a total of nine bits. In some embodiments, e.g., those in which data elements InDE and WtDE have the FP16 format, the multiplier circuit 106 is configured to generate each of products P[1]-P[N] having a total of 23 bits based on each of signed mantissas InS/InM and WtS/WtM and reformatted mantissas InTC and WtTC having a total of 12 bits. Embodiments in which the multiplier circuit 106 is configured to generate each of products P[1]-P[N] having other total bit numbers based on each of signed mantissas InS/InM and WtS/WtM and reformatted mantissas InTC and WtTC having other total bit numbers are within the scope of the present disclosure.

The multiplier circuit 106 is thereby configured to, in operation, perform multiplication and reformatting operations on sign and mantissa bits of input data elements InDE and weight data elements WtDE so as to generate two's complement products P[1]-P[N]. The multiplier circuit 106 is configured to output products P[1]-P[N] to the shifting circuit 112 on a data bus (not shown).

In various implementations, the multiplier circuit 106 can include one or more other components to perform the multiplication (or simplify the multiplication process). For example, the multiplier circuit 106 can include one or more multiplexers (MUX), switches, or other types of logic components. The multiplier circuit 106 may include other types of logic components configured to perform functions such as selecting one of multiple inputs to provide as an output based on the control signal.

In another example, the one or more logic gates M1 of the multiplier circuit 106 can be configured to receive a third input, in addition to the corresponding reformatted mantissa InTc and the reformatted mantissa WtTC. The third input can include or correspond to the control signal from the corresponding control circuit 120, including a value of 0 or 1. The one or more logic gates M1 can multiply the reformatted mantissas InTc and the reformatted mantissas WtTC by the control signal. In such cases, depending on the control signal, the one or more logic gates M1 can either output 0 (e.g., the control signal=0) as the product P[n] or output the product of the reformatted mantissa InTc and the reformatted mantissa WtTC (e.g., the control signal=1).

The summing circuits 108 each include one or more data registers (not shown) configured to receive the instances of exponents InE and WtE corresponding to the number of data elements of data elements InDE and WtDE discussed above with respect to the multiplier circuit 106.

The summing circuits 108 each include one or more logic gates A1 configured to, in operation, add each instance of exponent InE to each instance of exponent WtE. In various embodiments, the one or more logic gates A1 include one or more full adder gates, half adder gates, ripple-carry adder circuits, carry-save adder circuits, carry-select adder circuits, carry-look-ahead adder circuits, or other circuits suitable for performing some or all of an addition operation. The respective logic gates A1 of the summing circuits 108 are configured to generate exponent sums S[1]-S[N] as data elements having a total number of bits equal to the number of bits of each of exponents InE and WtE plus one.

The summing circuits 108 are configured to, in operation, generate the exponent sums S[1]-S[N] having the total number N and an ordering of data elements corresponding to the total number N and ordering of the data elements of the products P[1]-P[N] discussed above with respect to the multiplier circuit 106. Accordingly, for a total of N combinations of data elements InDE and WtDE, each n^{th} combination corresponds to both the n^{th} exponent sum S[n] of the exponent sums S[1]-S[N] and the n^{th} product P[n] of the products P[1]-P[N].

In some embodiments, e.g., those in which the data elements InDE and WtDE have the BF16 format, the summing circuit 108 is configured to generate each corresponding one of the exponent sums S[1]-S[N] having a total of nine bits based on each of the exponents InE and WtE having a total of eight bits. In some embodiments, e.g., those in which the data elements InDE and WtDE have the FP16 format, the summing circuit 108 is configured to generate each of the sums S[0]-S[N] having a total of six bits based on each of exponents InE and WtE having a total of five bits. The summing circuit 108 being configured to generate each of the exponent sums S[1]-S[N] having other total bit numbers based on each of exponents InE and WtE having other total bit numbers is within the scope of the present disclosure. The summing circuits 108 are configured to output the exponent sums S[1]-S[N] to the difference circuit 110 on a data bus (not shown).

The difference circuit 110 is an electronic circuit, e.g., an IC, including one or more logic gates L1 (e.g., corresponding to or as a part of a selector circuit 111) and one or more logic gates B1, each configured to receive the exponent sums S[1]-S[N] from the summing circuits 108. The one or more logic gates L1 may sometimes referred to as a selector, and the one or more logic gates B1 may sometimes be referred to as a subtractor. The one or more logic gates L1 are configured to, in operation, generate a maximum exponent sum MaxExp as a data element having a value equal to a maximum value of the data elements of the exponent sums S[1]-S[N] and having a number of bits equal to those of the data elements of the exponent sums S[1]-S[N]. The one or more logic gates L1 are configured to output maximum exponent sum MaxExp to the one or more logic gates B1 and to the converter circuit 124, as discussed below.

The one or more logic gates B1 are configured to, in operation, generate differences D[1]-D[N] by subtracting each data element of the exponent sums S[1]-S[N] from maximum exponent sum MaxExp. The differences D[1]-D[N] thereby have the total numberN and ordering of data elements corresponding to that of the exponent sums S[1]-S[N] and the products P[1]-P[N] discussed above. In the embodiment depicted in FIG. 1, the one or more logic gates B1 are configured to output differences D[1]-D[N] to the shifting circuit 112 and the control circuit 120 on one or more data buses (not shown). In some embodiments, the one or more logic gates B1 are not configured to output the differences D[1]-D[N] to the multiplier circuits 106, and the multiplier circuits 106 are each configured to generate each instance P[n] of products P[1]-P[N] by always performing the multiplying operation. In some other embodiments, the one or more logic gates B1 are configured to output the differences D[1]-D[N] to the multiplier circuits 106, respectively, and the multiplier circuits 106 are each configured to generate each instance P[n] of products P[1]-P[N] by selectively performing the multiplying operation based on a corresponding instance D[n].

The comparator circuits 120 are each an electronic circuit, e.g., an IC, configured to receive, e.g., from the difference circuit 110, one of the corresponding differences D[1]-D[N] representing the difference between at least one of the exponent InE or the exponent WtE and the maximum exponent sum MaxExp. The comparator circuits 120 are configured to, in operation, compare the received differences D[1]-D[N] to an exponent sum threshold (e.g., sometimes referred to as an exponent difference threshold). The exponent sum threshold can be predefined or pre-configured for specific machine learning applications. The exponent sum threshold can be configured based on the desired precision for the output of the MAC operation.

In some configurations, the circuit 100 may set the exponent sum threshold based on the precision of the mantissa InM or the mantissa WtM (e.g., a portion of the input values) or the format of the input values (e.g., data elements from the input circuit 104). For example, the data elements InDE and WtDE can have FP16 format, including 1 sign bit, 5 exponent bits, and 10 mantissa bits. The output of the MAC operation (e.g., an output from the converter 118) can have the same or different format (e.g., FP32 format, including 1 sign bit, 8 exponent bits, and 23 mantissa bits, or other formats). In this case, the precision can be set to the number of bits (e.g., precision) of the mantissa InM or the mantissa WtM (e.g., 10 mantissa bits).

In some configurations, the circuit 100 may set the exponent sum threshold based on a predetermined round-up value from the least significant bit (LSB), e.g., by configuring the exponent sum threshold as the number of mantissa bits plus a number of extra bits. For example, referring to the aforementioned examples, where the data elements InDE and WtDE can have FP16 format and the MAC operation output can have FP32 format, the circuit 100 can set the exponent sum threshold as the precision of the data elements plus one or more extra bits. In some cases, the extra bits can be predefined. In some other cases, the extra bits may be based on the specific architecture or implementation of the circuit 100 or CIM, where 6 extra bits can be set for 64-bit MAC CIM and 5 extra bits can be set for 32-bit MAC CIM. Using 6 extra bits as an example, the circuit 100 can set the exponent sum threshold as 16 (e.g., 10 mantissa bits associated with the data elements and 6 extra bits according to the specific architecture).

The comparator circuits 120 are configured to, in operation, generate control signals C[1]-C[N] having the total number N corresponding to the total number N of at least one of the multiplier circuits 106, the summing circuits 108, and/or the differences D[1]-D[N]. The generated control signals C[1]-C[N] can be based on or according to the comparison of the differences D[1]-D[N] to the exponent sum threshold. Each of the comparator circuits 120 can generate a corresponding instance C[n] of the control signals C[1]-C[N]. The comparator circuits 120 can include one or more components capable of or suitable for executing the comparison and generation operations, for example.

For example, the control circuit 120 can generate the control signal C[n] based on whether the corresponding difference D[n] satisfies the exponent sum threshold (e.g., by performing the comparison). Satisfying the exponent sum threshold can refer to the difference D[n] being greater than or equal to the exponent sum threshold, for example. The control signal C[n] can be 0 or 1 depending on the result of the comparison. If the difference D[n] is less than the exponent sum threshold, the control circuit 120 can generate a control signal C[n] of 1. If the difference D[n] is greater than or equal to the exponent sum threshold, the control circuit 120 can generate a control signal C[n] of 0. In some configurations, the control circuit 120 can generate a control signal C[n] of 1 if the difference D[n] is greater than or equal to the exponent sum threshold and a control signal C[n] of 0 if the difference D[n] is less than the exponent sum threshold, for example. The control circuit 120 can provide the control signal C[n] to the corresponding multiplier circuit 106 or at least one component of the multiplier circuit 106.

It should be noted that the variables or values, such as the exponent sum threshold, the input values, the formats, etc., are not limited to the examples provided herein, and other variables or values can be used similarly by the circuit 100 or other devices or components thereof, such as different exponent sum thresholds, formats, etc., to perform the MAC operation for the floating point numbers with reduced computation resources. Further, it should be noted that more or less components and/or different arrangements of the one or more components can be implemented to perform the features, operations, or procedures discussed herein.

In various arrangements, the operations of at least one of the summing circuits 108, the difference circuit 110, and/or the comparator circuits 120 can be performed before, after, or in parallel to the multiplier circuits 106. In some arrangements, the operations of the individual summing circuits 108, the difference circuit 110, or the comparator circuits 120 may be performed sequentially or in parallel.

The shifting circuit 112 is an electronic circuit, e.g., an IC, including one or more registers and/or logic gates configured to perform a shifting operation on each instance P[n] of the products P[1]-P[N] based on the value of the corresponding instance D[n] of the differences D[1]-D[N].

Each instance P[n] of the products P[1]-P[N] is based on the sign and mantissa of a corresponding combination of data elements InDE and WtDE, and each instance D[n] of the differences D[1]-D[N] is based on the sum of the exponents of the same combination. The shifting circuit 112 is configured to, in operation, right-shift each instance P[n] of the products P[1]-P[N] by an amount equal to the corresponding difference D[n], thereby generating shifted products SP[1]-SP[N] in which sign and mantissa bits are aligned in accordance with the summed exponents used to generate the differences D[1]-D[N]. Based on this alignment, the shifting circuit 112 is configured to generate each instance SP[n] of the shifted products SP[1]-SP[N] having a same exponent using the maximum exponent sum MaxExp as a baseline.

To compensate for the right-shifting operation, the shifting circuit 112 can add instances of the sign bit (zero or one) of each product P[n] as the leftmost bits of the corresponding shifted product SP[n]. The number of added instances of the sign bit is equal to the amount of the right shift as determined by the corresponding difference D[n].

In the illustrated embodiment of FIG. 1, the multiplier circuit 106 can generate the corresponding instance P[n] of the products P[1]-P[N] by performing the multiplying operation, as discussed above. The shifting circuit 112 can include one or more shifters to receive the products P[1]-P[N] from the multiplier circuits 106, and selectively output (e.g., shift) one or more of the shifted products SP[1]-SP[N] to the adder circuit 114 based on the respective differences D[1]-D[N]. For example in FIG. 1, the shifted products outputted to the adder circuit 114 may include SP[w]-SP[z], where “w” to “z” may each be one of the integers from 1 to N. In one aspect of the present disclosure, a sum of the number of SP[w]-SP[z] may be equal to N. In another aspect of the present disclosure, a sum of the number of SP[w]-SP[z] may be less than N.

The shifting circuit 112 (e.g., the shifters) can be controlled (e.g., activated) by a number (e.g., N) of signals generated based on comparing corresponding ones of the differences D[1]-D[N] with a difference threshold (not shown in FIG. 1). The difference threshold can be configured based on a distribution of the differences D[1]-D[N]. In an example where the differences D[1]-D[N] are presented as a normal distribution, the difference threshold may be determined at one standard deviation below a mean of the normal distribution. In another example where the differences D[1]-D[N] are still presented as a normal distribution, the difference threshold may be determined at two standard deviations below a mean of the normal distribution. In yet another example where the differences D[1]-D[N] are still presented as a normal distribution, the difference threshold may be determined at any value of standard deviations below a mean of the normal distribution.

When any of the difference, e.g., D[n] where n is an integer between 1 to N, is equal to or less than the difference threshold (sometimes referred to as a “small exponent difference”), the shifting circuit 112 (e.g., the shifter) can be deactivated to block the corresponding shifted product SP[n] from being received by the adder circuit 114 (e.g., not shifting the corresponding product P[n] or being decoupled from the adder circuit 114). Equivalently, when any of the difference, e.g., D[n], is greater than the difference threshold (sometimes referred to as a “normal exponent difference”), the shifting circuit 112 can be activated to output the corresponding shifted product SP[n] to the adder circuit 114.

In other words, the shifting circuit 112 can shift any of the products P[1]-P[N], and output the shifted products SP[1]-SP[N] to the adder circuit 114 based on comparing the respective differences D[1]-D[N] with the difference threshold. As such, a sum of the number of SP[w]-SP[z] may be equal to N. In some configurations, the shifting circuit 112 may detect that at least one of the products P[1]-P[N] from the multiplier circuits 106 is zero. In such cases, the shifting circuit 112 may not perform a shift to the corresponding product with a value of zero and/or output the product to the adder circuit 114. As a result, the sum of the number of SP[w]-SP[z] may be less than N.

Further, to generate the SP[w]-SP[z], the shifting circuit 112 may right-shift each instance P[n] of the products P[w]-P[z] by an amount equal to a corresponding difference DA[n], thereby aligning sign and mantissa bits in accordance with the summed exponents. In some embodiments, the difference DA[n] may be generated (e.g., by the difference circuit 110) based on subtracting each data element of sums S[w]-S[z] from a maximum exponent sum MaxExp. The maximum exponent sum MaxExp may correspond to a maximum value of the data elements of the sums S[w]-S[z]. Based on this alignment, the shifting circuit 112 can generate each instance SP[n] of the shifted products SP[w]-SP[z] having a same exponent using the maximum exponent sum MaxExp as a baseline.

When any of the differences, e.g., D[n] where n is an integer between 1 to N, is equal to or less than the difference threshold (sometimes referred to as a “small exponent difference”), the shifting circuit 112 may be deactivated to block the corresponding (e.g., shifted) product SP[n] from being received by the adder circuit 114. The product P[n] with such a big exponent difference may be ignored, in some embodiments.

In other words, the shifting circuit 112 can shift all or some of the products P[1]-P[N], and selectively output the corresponding ones of the shifted products SP[1]-SP[N] to the adder circuit 114, based on comparing the respective differences D[1]-D[N] with the difference threshold. As such, a sum of the number of SP[w]-SP[z](outputted by the shifting circuit 112) may be less than or equal to N. When one or more of the products P[1]-P[N] are ignored (e.g., having their respective exponent differences D[n] equal to or greater than the difference threshold), the sum is less than N; and when none of the products P[1]-P[N] is ignored, the sum is equal to N.

In some embodiments, the multiplier circuits 106 can receive the differences D[1]-D[N] from the difference circuit 110 to determine whether the difference D[n] is greater than or equal to the exponent sum threshold (e.g., sometimes referred to as an exponent difference threshold).

In some embodiments, e.g., those in which the data elements InDE and WtDE have the BF16 format, the shifting circuit 112 is configured to generate each of the shifted products, e.g., the SP[0]-SP[N], having a total of 21 bits based on each of the products P[0]-P[N] having a total of 17 bits. In some embodiments, e.g., those in which the data elements InDE and WtDE have the FP16 format, the shifting circuit 112 is configured to generate each of the shifted products, e.g., the SP[0]-SP[N], having a total of 27 bits based on each of the products P[0]-P[N] having a total of 23 bits. The shifting circuit 112 being configured to generate each of the shifted products SP[0]-SP[N] having other total bit numbers based on each of the products P[0]-P[N] having other total bit numbers is within the scope of the present disclosure.

Based on the products P[0]-P[N] having a two's complement format, the shifting circuit 112 is configured to generate the shifted products, e.g., SP[0]-SP[N], having a two's complement format. As discussed above, in the illustrated example of FIG. 1, the shifting circuit 112 is configured to output the shifted products SP[w]-SP[z] to the adder circuit (tree) 114 on a data bus (not shown).

The adder tree 114 is an electronic circuit, e.g., an IC, including multiple layers of one or more logic gates (not shown), e.g., as discussed above with respect to one or more logic gates A1 (of the summing circuit 108). For example, the adder tree 114 may include a first layer configured to receive the shifted products SP[w]-SP[z], and a last layer configured to generate a sum 115 as a data element corresponding to a sum of the shifted products SP[w]-SP[z]. In some embodiments, each of one or more successive layers between the first and last layers is configured to receive a first number of sum data elements generated by a preceding layer, and generate a second number of sum data elements based on the first number of sum data elements, the second number being half the first number. Thus, a total number of layers includes the first and last layers and each successive layer, if present.

The sum PSTC (e.g., corresponding to the sum 115) is sometimes referred to as partial sum PSTC or mantissa sum PSTC in some embodiments, having a total number of bits corresponding to the number of bits and number of data elements of the shifted products SP[w]-SP[z]. In some embodiments, the number of bits of sum PSTC is equal to the number of bits of shifted products SP[w]-SP[z] plus a number of bits capable of representing the number of data elements of shifted products SP[w]-SP[z]. In some embodiments, the number of bits of sum PSTC is equal to the number of bits of shifted products SP[w]-SP[z] plus four bits capable of representing 16 data elements of shifted products SP[w]-SP[z].

In some embodiments, e.g., those in which data elements InDE and WtDE have the BF16 format, the adder tree 114 is configured to generate the sum PSTC having a total of 25 bits based on each of the shifted products SP[w]-SP[z] having a total of 21 bits. In some embodiments, e.g., those in which data elements InDE and WtDE have the FP16 format, the adder tree 114 is configured to generate the sum PSTC having a total of 31 bits based on each of the shifted products SP[w]-SP[z] having a total of 27 bits. The adder tree 114 being configured to generate the sum PSTC based on each of the shifted products SP[w]-SP[z] having other total bit numbers is within the scope of the present disclosure.

Based on the shifted products SP[w]-SP[z] having a two's complement format, the adder tree 114 is configured to generate the sum PSTC having a two's complement format, in accordance with various embodiments of the present disclosure. As such, the adder tree 114 is configured to output the sum PSTC to the converter 116 on a data bus (not shown). In some other embodiments, the adder tree 114 may output the sum PSTC to a circuit (not shown) external to the circuit 100.

The converter 116 is an electronic circuit, e.g., an IC, including logic circuitry configured to, in operation, receive the sum PSTC from the adder tree 114, and convert the sum PSTC from two's complement to a sum PSSM having a sign plus mantissa format. The converter 116 is configured to generate the sum PSSM having a same number of bits as that of the sum PSTC. In the embodiment depicted in FIG. 1, the converter 116 is configured to further output the sum PSSM to the converter 118 on a data bus (not shown). In some other embodiments, the converter 116 may output the sum PSSM to a circuit (not shown) external to the circuit 100.

The converter 118 is an electronic circuit, e.g., an IC, including logic circuitry configured to, in operation, receive the sum PSSM from the converter 116 and the maximum exponent sum MaxExp from the difference circuit 110, and convert the sum PSSM from the sign plus mantissa format to a sum PS having an output format based on the sum PSSM and the MaxExp and different from the sign plus mantissa format, e.g., a floating point format as discussed above. In various embodiments of the present disclosure, the converter 118 can generate the sum PS configured to be compatible with a circuit (not shown) external to the circuit 100. For example, the converter 118 is configured to output the sum PS to a circuit (not shown) external to the circuit 100, e.g., a memory array or other instance of the circuit 100 as part of a convolutional neural network (CNN). In some arrangements, the converter 116 can be a part of the converter 118, or vice versa. The MUX 122 can be positioned between the converter 116 and the converter 118 such that the MUX 112 can receive an output from the converter 116 and provide an output to the converter 118.

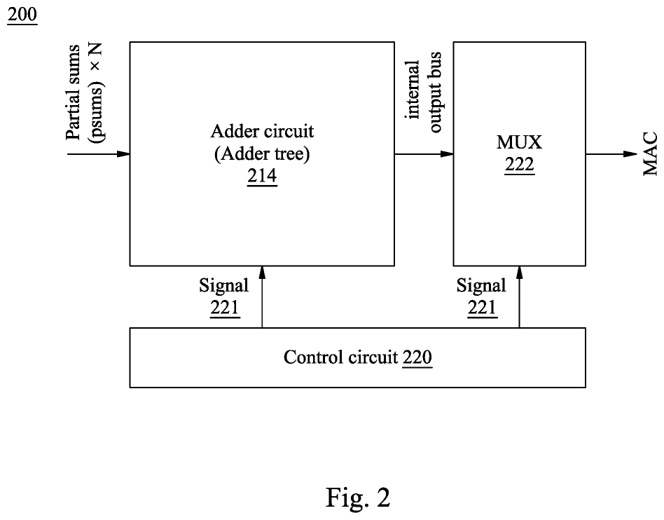

FIG. 2 illustrates a block diagram of a portion (hereinafter referred to as a “configurable circuit” 200) of an example data computation circuit (e.g., the data computation circuit 100), in accordance with some embodiments of the present disclosure. The configurable circuit 200 can include an adder circuit 214, a control circuit 220, and a MUX 222, which may be substantially similar to or incorporate features of the adder circuit 114, the control circuit 120, and the MUX 122, respectively. In a brief overview, the adder circuit 214 can receive partial sums (psums) and provide an output to the MUX 222 through an internal output bus. The MUX 222 can receive the output from the adder circuit 214 and output a result of the MAC operation. The control circuit 220 can provide a signal 221 to the adder circuit 214 and the MUX 222 to configure the adder circuit 214 and the MUX 222. In some embodiments, the adder circuit 214 can be configured to have different configuration for different numbers of accumulation, as described in greater detail below. For example, the adder circuit 214 can be configured to support accumulation in point wise convolution layers (e.g., a high number of accumulation, 16, 32, 64, etc.). The adder circuit 214 can be configured to support accumulation in depth wise convolution layers (e.g., a low number of accumulation, 8, etc.). In some embodiments, the MUX 222 can be configured to output a result of the MAC operation for different numbers of accumulations (e.g., 8, 16, 32, 64, etc.). The configurable circuit 200 shown in FIG. 2 is a non-limiting example.

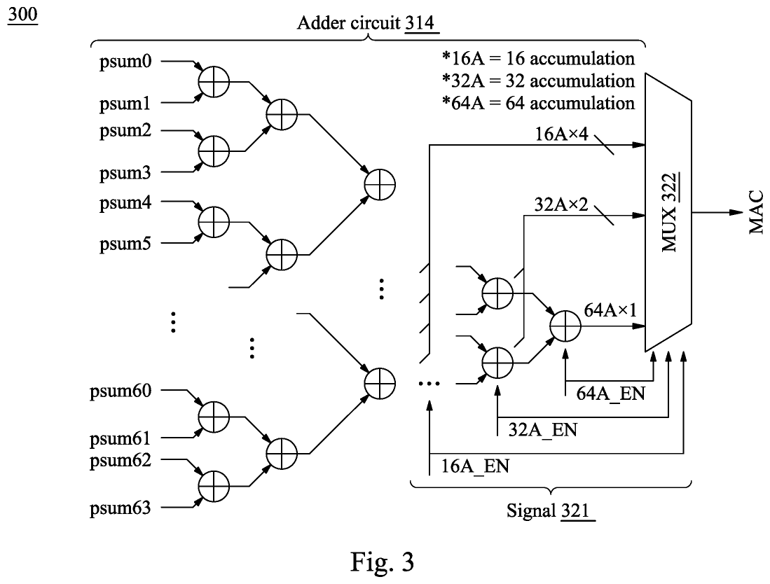

FIG. 3 illustrates a schematic diagram of an example configurable circuit 300, in accordance with some embodiments of the present disclosure. In FIG. 3, the configurable circuit 300 is shown to include an adder circuit 314 and a MUX 322, which may be substantially similar to or incorporate features of the adder circuit 214 and the MUX 222, respectively. The configurable circuit 200 shown in FIG. 2 is a non-limiting example.

As shown, the adder circuit 314 can receive partial sums psum0-psum 63 and perform addition operations for the received psums. The adder circuit 314 can provide a result of the addition operations to the MUX 322, which can output a result of the MAC operation. In some embodiments, the adder circuit 314 can receive a signal 321 (e.g., from the control circuit 220) and can be configured to support different numbers of accumulations. For example, the adder circuit 314 can receive the signal 321 (e.g., 16A_EN) indicating 16 accumulation (16A) and then can be configured to provide 4 results of 16A (16A×4), without proceeding to a next addition operation (e.g., 32A). The MUX 322 can receive the signal 321 (e.g., 16A_EN) indicating 16A, and can receive the results of 16A×4 from the corresponding adders (e.g., which perform 16A). The MUX 322 can output a result of the MAC based on the received results of 16A×4. Likewise, the adder circuit 314 can receive the signal 321 (e.g., 32A_EN) indicating 32A accumulation (32A) and then can be configured to provide 2 results of 32A (32A×2), without proceeding to a next addition operation (e.g., 64A). The MUX 322 can receive the signal 321 (e.g., 32A_EN) indicating 32A, and can receive the results of 32A×2 from the corresponding adders (e.g., which perform 32A). The MUX 322 can output a result of the MAC based on the received results of 32A×2. Likewise, the adder circuit 314 can receive the signal 321 (e.g., 64A_EN) indicating 64A accumulation (64A) and then can be configured to provide 1 result of 64A (64A×1). The MUX 322 can receive the signal 321 (e.g., 64A_EN) indicating 64A, and can receive the results of 64A×1 from the corresponding adder (e.g., which performs 64A). The MUX 322 can output a result of the MAC based on the received results of 64A×1. This allows for a configurable number of accumulation (e.g., configurable between various numbers of accumulation), thereby improving the CIM utilization and taking preventive measures for the multipliers to reduce computation/calculation resource/power usage for the MAC operation.

In some embodiments, as shown in FIG. 3, the configurable circuit 300 (e.g., the adder circuit 314) can receive a plurality of input data bits (e.g., psums) as an input. In response to receipt of the input data bits, the configurable circuit 300 can identify a number of accumulation associated with the received input data bits. For example, based on the input data bits (e.g., psums), the configurable circuit 300 can determine the number of accumulation to be performed. In some embodiments, based on the number of accumulation, the configurable circuit 300 can determine whether to enable or disable at least one component of the adder circuit 314. For example, when the number of accumulation is determined to be 16A×4, the configurable circuit 300 can determine disabling circuit components that perform addition operations for 32A×2 and 64A×1, thereby allowing for the result of 16A×4 addition operations to be provided to the MUX 322. Likewise, when the number of accumulation is determined to be 32A×2, the configurable circuit 300 can determine disabling circuit components that perform addition operations for 64A×1, thereby allowing for the result of 32A×2 addition operations to be provided to the MUX 322. When the number of accumulation is determined to be 64A×1, the configurable circuit 300 can determine enabling circuit components that perform addition operations for 16A×4, 32A×2, and 64A×1. In some embodiments, the signal 321 can include an indication to enable or disable the at least one component of the configurable circuit 300. For example, when the number of accumulation is determined to be 16A×4, the configurable circuit 300 can generate the signal 321 indicating 16A_EN and disable components that perform addition operations for 32A×2 and 64A×1. Likewise, when the number of accumulation is determined to be 32A×2, the configurable circuit 300 can generate the signal 321 indicating 32A_EN and disable components that perform addition operations for 64A×1. Likewise, when the number of accumulation is determined to be 64A×1, the configurable circuit 300 can generate the signal 321 indicating 64A_EN and enable components that perform addition operations for 16A×4, 32A×2, and 64A×1.

In some embodiments, the MUX 322 can receive the signal 321 indicating the number of accumulation and can be configured to output a result of the MAC operation according to the number of accumulation. For example, when the MUX 322 receives the signal indicating 16A_EN, the MUX 322 can provide four results as an output of the MAC operation for 16A×4. Likewise, when the MUX 322 receives the signal indicating 32A_EN, the MUX 322 can provide two results as an output of the MAC operation for 32A×2. Likewise, when the MUX 322 receives the signal indicating 64A_EN, the MUX 322 can provide one result as an output of the MAC operation for 64A×1.

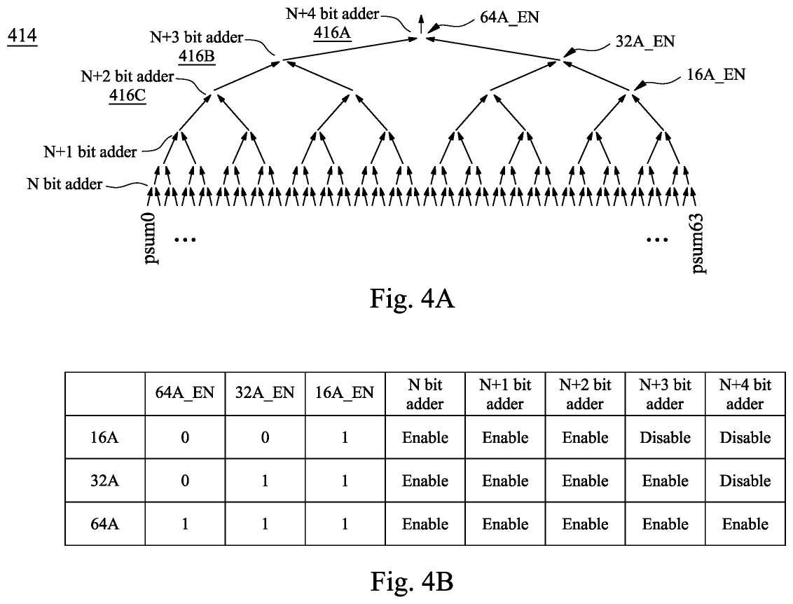

FIG. 4A illustrates a schematic diagram of an example adder circuit 414, in accordance with some embodiments of the present disclosure. The adder circuit 414 may be substantially similar to or incorporate features of the adder circuit 214. The adder circuit 414 shown in FIG. 4A is a non-limiting example. FIG. 4B tabulates example status of components (e.g., N+4 bit adder, N+3 bit adder, etc.) in the adder circuit 414 for different numbers of accumulations (e.g., 16A, 32A, 64A, etc.), in accordance with some embodiments of the present disclosure.

In some embodiments, when the adder circuit 414 receives a signal indicating 16A accumulation, at least the adder for 16A (e.g., up to N+2 bit adder 416C, including N+1 bit adder, N bit adder, etc.) can be enabled (e.g., set to “1”) by 16A_EN, while the adders for 32A and 64A (e.g., N+3 bit adder 416B and N+4 bit adder 416A) can be disabled (e.g., set to “0”). This allows for a result of the addition operations (e.g., 16A×4) to be output at the N+2 bit adder 416C (e.g., to the MUX 222). When the adder circuit 414 receives a signal indicating 32A, at least the adders for 16A and 32A (e.g., up to N+3 bit adder 416B, including N+2 bit adder 416C, N+1 bit adder, N bit adder, etc.) can be enabled (e.g., set to “1”) by 32A_EN and 16A_EN, while the adder for 64A (e.g., N+4 bit adder 416A) can be disabled (e.g., set to “0”). This allows for a result of the addition operations (e.g., 32A×2) to be output at the N+3 bit adder 416B (e.g., to the MUX 222). When the adder circuit 414 receives a signal indicating 64A, the adders for 16A, 32A, and 64A (e.g., up to N+4 bit adder 416C, including N+3 bit adder 416B, N+2 bit adder 416C, N+1 bit adder, N bit adder, etc.) can be enabled (e.g., set to “1”) by 64A_EN, 32A_EN, and 16A_EN. This allows for a result of the addition operations (e.g., 64A×1) to be output at the N+4 bit adder 416A (e.g., to the MUX 222).

The adder circuit 414 and the status of the adding components according to the different signals shown in FIG. 4A and FIG. 4B are non-limiting examples, and the numbers of accumulations and/or the number of MAC outputs are not limited to 16, 32, or 64. That is, in some embodiments, the configurable circuits disclosed herein can be used for any number of accumulations, such that a first output of the adder circuit 414 can include a first set (e.g., 2) of output bits (e.g., 32A) when disabling a first number (e.g., 1) of components, and a second output can include a second set (e.g., 1) of output bits (e.g., 64A) when disabling a second number (e.g., 0), wherein a number of the first set is larger than a number of the second set, and the first number is larger than the second number. Although described with 32A×2 and 64A×1 as an example, the configurable circuits disclosed herein can be used for any number (e.g., 128) of accumulations.

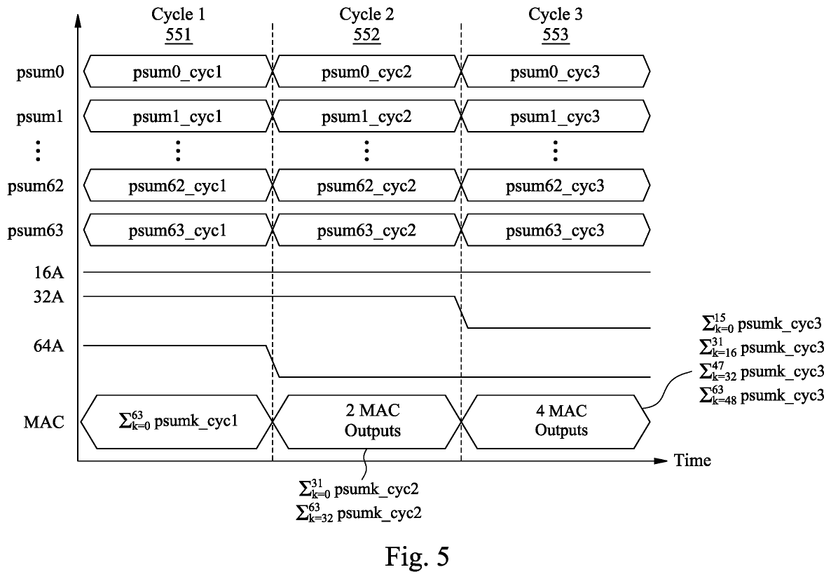

FIG. 5 illustrates an example plot of signals associated with the adder circuit 414, in accordance with some embodiments of the present disclosure. In some embodiments, the adder circuit 414 can receive a signal indicating different numbers of accumulations during different cycles. For example, the signal can include a first logic value at a first time, and a second logic value at a second time. Referring to FIG. 5, during a first cycle 551 (e.g., a first time), the adder circuit 414 can receive a signal indicating 64A (e.g., 16A, 32A, and 64A set to “1” (enabled) according to FIG. 4B). The adder circuit 414 can perform the addition operations for psums from psum0 to psum63, and then output a result, Σₖ₌₀⁶³ psumk_cyc1 (e.g., 64A×1). During a second cycle 552 (e.g., a second time), the adder circuit 414 can receive a signal indicating 32A (e.g., 16A and 32A set to “1” (enabled); 64A sent to “0” (disabled) according to FIG. 4B). The adder circuit 414 can perform the addition operations for a first set of psums from psum0 to psum31 and a second set of psums from psum32 to psum63, and then output a result (e.g., 2 MAC outputs), Σₖ₌₀³¹ psumk_cyc2 and Σₖ₌₃₂⁶³ psumk_cyc2 (e.g., 32A×2). During a third cycle 553 (e.g., a third time), the adder circuit 414 can receive a signal indicating 16A (e.g., 16A set to “1” (enabled); 32A and 64A sent to “0” (disabled) according to FIG. 4B). The adder circuit 414 can perform the addition operations for a first set of psums from psum0 to psum15, a second set of psums from psum16 to psum31, a third set of psums from psum32 to psum47, and a fourth set of psums from psum48 to psum63 and then output a result (e.g., 4 MAC outputs), Σₖ₌₀¹⁵ psumk_cyc3, Σₖ₌₁₆³¹ psumk_cyc3, Σₖ₌₃₂⁴⁷ psumk_cyc3, and Σₖ₌₄₈⁶³ psumk_cyc3 (e.g., 16A×4).

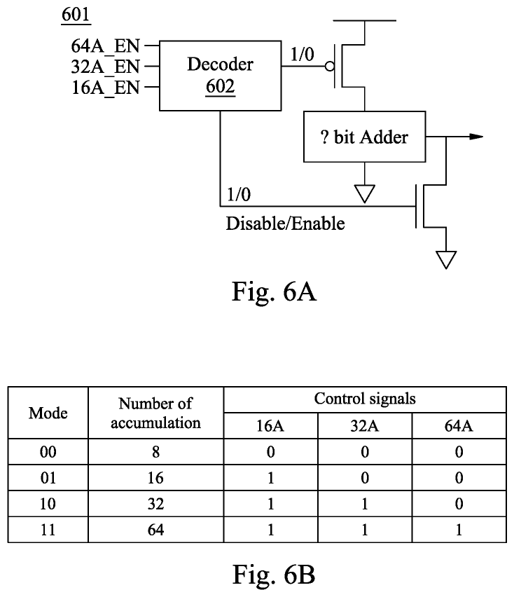

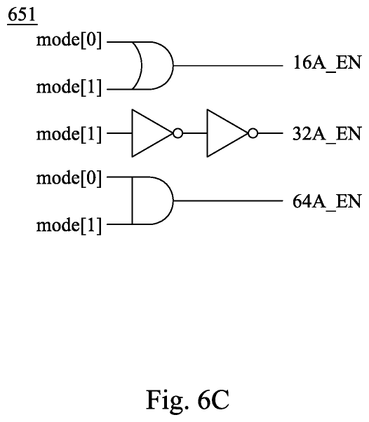

FIG. 6A illustrates an example logic circuit 601 that can be coupled with the configurable circuit 200, in accordance with some embodiments of the present disclosure. In some embodiments, the logic circuit 601 can receive a signal (e.g., the signal 221) from a control circuit (e.g., the control circuit 220). In response to receipt of the signal, the logic circuit 601 can control the adder circuit 214. In some embodiments, the logic circuit 601 can include a decoder 602 to read/decode the signal from the control circuit and can provide a signal to enable/disable the adders (e.g., the bit adders 416A, 416B, 416C in FIG. 4A). In some embodiments, the logic circuit 601 can generate a plurality of logic values and/or logic modes, each of which indicates a number of the adders to be disabled or enabled.

FIG. 6B tabulates example modes with respect to the numbers of accumulations and corresponding control signals, in accordance with some embodiments of the present disclosure. In some embodiments, the control circuit (e.g., the control circuit 220) can generate a control signal (e.g., the signal 221) that can represent four modes (e.g., mode[1:0]). For example, when the control signal represents a mode of “11,” the control circuit can decode the control signal and identify the number of accumulation to be “64.” In response to identifying the number of accumulation, the control circuit can generate control signals to set the adders for 16A, 32A, and 64A to “1” (enabled), thereby performing the addition operations up to 64A and outputting a result of 64A×1. Likewise, when the control signal represents a mode of “10,” the control circuit can decode the control signal and identify the number of accumulation to be “32.” In response to identifying the number of accumulation, the control circuit can generate control signals to set the adding components for 16A and 32A to “1” (enabled) and set the adding components for 64A to “0” (disabled), thereby performing the addition operations up to 32A and outputting a result of 32A×2. Likewise, when the control signal represents a mode of “01,” the control circuit can decode the control signal and identify the number of accumulation to be “16.” In response to identifying the number of accumulation, the configurable circuit can generate control signals to set the adding components for 16A to “1” (enabled) and set the adding components for 32A and 64A to “0” (disabled), thereby performing the addition operations up to 16A and outputting a result of 16A×4. Likewise, when the control signal represents a mode of “00,” the control circuit can decode the control signal and identify the number of accumulation to be “8.” In response to identifying the number of accumulation, the configurable circuit can generate control signals to set the adding components for 16A, 32A, and 64A to “0” (disabled), thereby performing the addition operations up to 8A and outputting a result of 8A×8. The logic circuit 601 can include various logic components to decode signals from the control circuit and provide the control signal to enable/disable the adders. FIG. 6C illustrates example logic components 651 that can be coupled with the configurable circuit shown in FIG. 2, in accordance with some embodiments of the present disclosure. For example, the logic circuit 601 can include at least one of an OR gate, an AND gate, an NOR gate, a NAND gate, an XOR gate, a NOT gate, or any combination thereof.

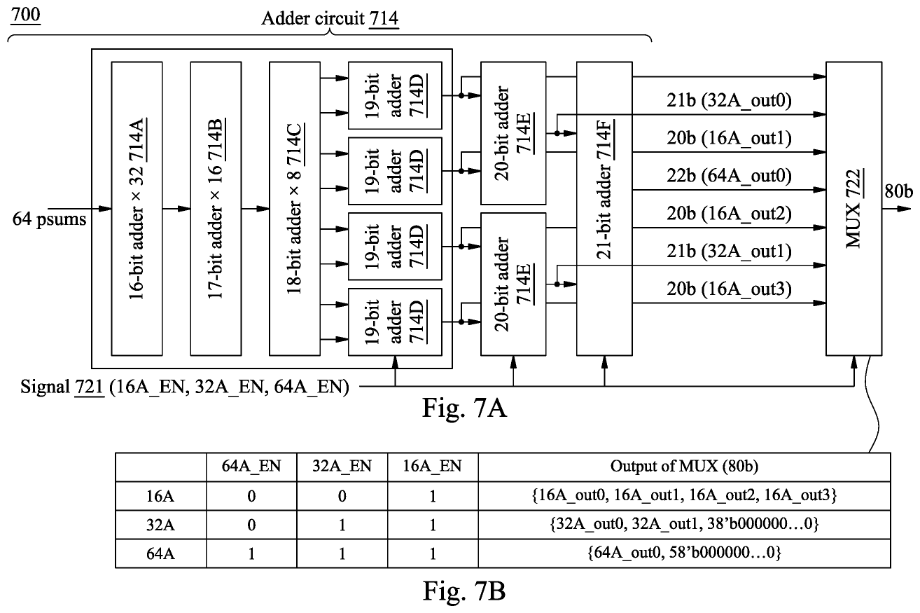

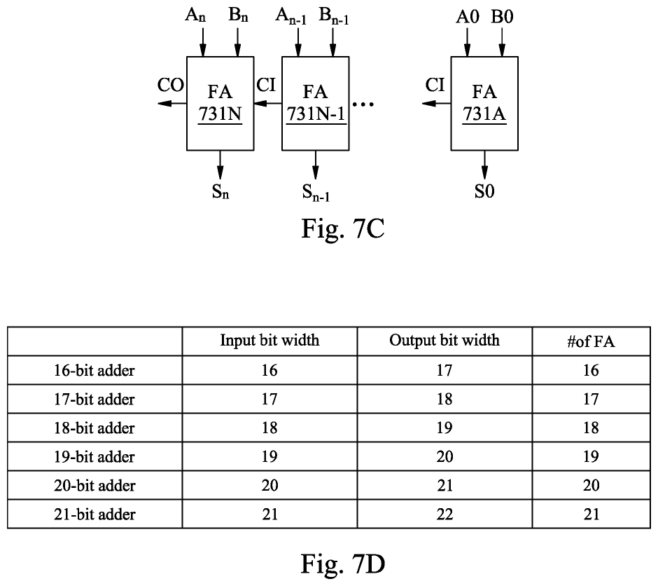

FIG. 7A illustrates a block diagram of an example configurable circuit 700, in accordance with some embodiments of the present disclosure. FIG. 7B tabulates example control signals and corresponding outputs of a MUX shown in FIG. 7A, in accordance with some embodiments of the present disclosure. In FIG. 7A, the configurable circuit 700 is shown to include an adder circuit 714 and a MUX 722, which may be substantially similar to or incorporate features of the adder circuit 214 and the MUX 222, respectively. The configurable circuit 700 shown in FIG. 7A is a non-limiting example.

The adder circuit 714 can include different bit adders, including 16-bit adders 714A, 17-bit adders 714B, 18-bit adders 714C, 19-bit adders 714D, 20-bit adders 714E, and 21-bit adders 714F. Each of the different bit adders can be configured to provide an accumulation of inputs as an output. The adder circuit 714 can receive partial sums (psums) (e.g., 64 psums) and perform addition operations through at least one of the different bit adders.

FIG. 7C illustrates a block diagram of the adder circuit 714, in accordance with some embodiments of the present disclosure. While shown in FIG. 7A is a non-limiting example of the adder circuit 714 including the bit adders 714A-714F, the adder circuit 714 shown in FIG. 7B can include a plurality of adders (e.g., 731A, . . . , 731N−1, 731N, etc.), where N can be any number of adders. For example, the adder 731A may be the 16-bit adders 714A in FIG. 7A, and the adder 731N may be the 21-bit adder 714F in FIG. 7A. Each of the adders, for example, 731N−1 can be configured to receive inputs Aₙ₋₁ and Bₙ₋₁, and can be configured to output a result of the addition operation according to a control signal. When the adder circuit 714 receives a control signal including a first logic value (e.g., “1” or an enabling signal) associated with a next adder, for example, 731N, the adder 731N−1 can provide the result of the addition operation as an input (carry in, “CI”) to the next adder, 731N. When the adder circuit 714 receives a control signal including a second logic value (e.g., “0” or a disabling signal) associated with the next adder, for example, 731N, the adder 731N−1 can provide the result of the addition operation (Sₙ₋₁) to the MUX 722.

FIG. 7D tabulates example bit numbers of the different adders shown in FIG. 7A, in accordance with some embodiments of the present disclosure. In some embodiments, as shown, the 16-bit adder 714A can have an input bit width of 16 (and a number of accumulation), and have an output bit width of 17. Likewise, the 17-bit adder 714B can have an input bit width of 17 (and a number of accumulation), and have an output bit width of 18; the 18-bit adder 714C can have an input bit width of 18 (and a number of accumulation), and have an output bit width of 19; the 19-bit adder 714D can have an input bit width of 19 (and a number of accumulation), and have an output bit width of 20; the 20-bit adder 714E can have an input bit width of 20 (and a number of accumulation), and have an output bit width of 21; and the 21-bit adder 714F can have an input bit width of 21 (and a number of accumulation), and have an output bit width of 22.

Referring to FIG. 7A, in some embodiments, a first component (e.g., the 19-bit adder 714D) can be configured to receive a plurality of input data bits (e.g., psums from the 18-bit adder 714C) and provide a first output (e.g., 20b (16A_out1-3)). When the adder circuit 714 receives a control signal including a first logic value (e.g., “1” and/or an enabling signal; for example, 32A_EN or 64A_EN to enable 32A) associated with a second component or the next adders (e.g., the 20-bit adder 714E), the second component can receive the first output from the first component and provide a second output (e.g., 21b (32A_out0-1)). When the adder circuit 714 receives a control signal including a second logic value (e.g., “0”; for example, 16A_EN to disable 32A) associated with the second component or the next adders (e.g., the 20-bit adders), the second component can be disabled, and the first output from the first component can be provided to the MUX 722. Therefore, the MUX 722 can be configured to output the first output in response to the control signal including the second logic value (associated with the 20-bit adder 714E), and configured to output the second output in response to the control signal including the first logic value (associated with the 20-bit adder 714E).

Likewise, the second component (e.g., the 20-bit adders 714E) can be configured to receive a plurality of input data bits (e.g., psums from the 19-bit adders) and provide the second output (e.g., 21b (32A_out0-1)). When the adder circuit 714 receives a control signal including a first logic value (e.g., “1” and/or an enabling signal; for example, 64A_EN to enable 64A) associated with a third component or the next adders (e.g., the 21-bit adders), the third component can receive the second output from the second component and provide a third output (e.g., 22b (64A_out0)). When the adder circuit 714 receives a control signal including a second logic value (e.g., “0”; for example, 32A_EN to disable 64A) associated with the third component or the next adders (e.g., the 21-bit adders), the third component can be disabled, and the second output from the second component can be provided to the MUX 722. Therefore, the MUX 722 can be configured to output the second output in response to the control signal including the second logic value (associated with the 21-bit adders), and configured to output the third output in response to the control signal including the first logic value (associated with the 21-bit adders).

In some embodiments, the MUX 722 can be configured to receive different sets of bits (e.g., 20b×4, 21b×2, 22b×1, etc.) from different sets of adders (e.g., the 19-bit adders 714D, the 20-bit adders 714E, the 21-bit adders 714F, etc.). In response to receipt of the bits from the adders, the MUX 722 can be configured to output a result of the MAC operation corresponding to the received bits. For example, when the MUX 722 receives 20b×4 from the 19-bit adders 714D and a signal indicating a corresponding number of accumulation (e.g., 16A), the MUX 722 can provide an output of the MAC operation, 16A_out0, 16A_out1, 16A_out2, and 16A_out3. When the MUX 722 receives 21b×2 from the 20-bit adders 714E and a signal indicating a corresponding number of accumulation (e.g., 32A), the MUX 722 can provide an output of the MAC operation, 32A_out0 and 32A_out1. When the MUX 722 receives 22b×1 from the 21-bit adder 714F and a signal indicating a corresponding number of accumulation (e.g., 64A), the MUX 722 can provide an output of the MAC operation, 64A_out0. In some embodiments, the MUX 722 can be configured to set at least one bit of the output bits to a logic state (e.g., “0”) when a number of the bits from the adders is smaller than a number of the MUX output bits. For example, when the MUX 722 is configured to output 80 bits (80b as shown), and the MUX 722 receives the bits (e.g., two 21-bit) from the 20-bit adders 714E, the MUX 722 can provide an 80-bit output including the 42 bits (32A_out0, 32A_out1) from the 20-bit adders 714E, and 38 bits of “0.” Likewise, when the MUX 722 is configured to output 80 bits (80b as shown), and the MUX 722 receives the bits (e.g., one 22-bit) from the 21-bit adders 714F, the MUX 722 can provide an 80-bit output including 22 bits (64A_out0) and 58 bits of “0.”

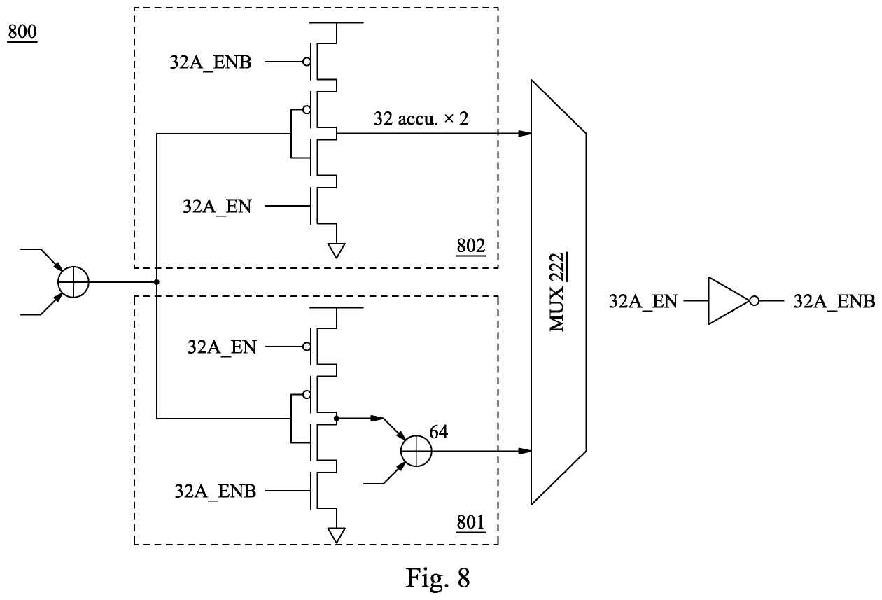

FIG. 8 illustrates an example selecting circuit 800 that can be coupled with the configurable circuit 200, in accordance with some embodiments of the present disclosure. In some embodiments, the selecting circuit 800 can be coupled with the MUX 222 to receive a result of the addition operations from the adder circuit 214 and provide the result to the MUX 222. In some embodiments, the selecting circuit 800 can include a first circuit 801 to receive and output a first set of bits (e.g., 64A×1) in response to enabling the corresponding adders (e.g., for 16A, 32A, 64A). The selecting circuit 800 can include a second circuit 802 to receive and output a second set of bits (e.g., 32A×2) in response to disabling at least one adder (e.g., for 64A).

As shown, in some examples, the selecting circuit 800 can include a plurality of circuit components (e.g., switches, transistors, etc.) to receive a set of bits from the adder circuit 214 and output the same to the MUX 222. For example, the selecting circuit 800 can receive a control signal (e.g., the signal 221 from the control circuit 220), for example, 32A_EN and 32_ENB, and select the first circuit or the second circuit to provide the received bits to the MUX 222. Although depicted and described with respect to the addition operations of 32A and 64A, the selecting circuit 800 can be used for any number of accumulation (e.g., 8A, 16A, 32A, 64A, etc.).

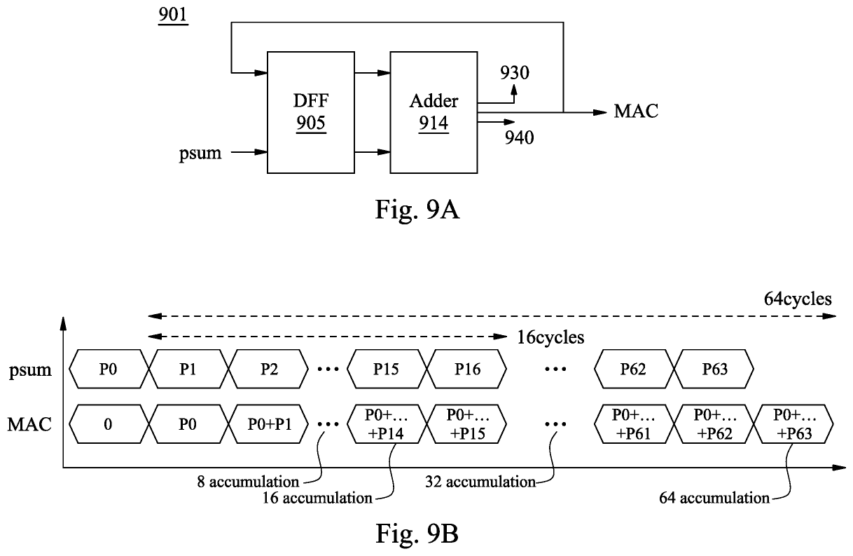

FIG. 9A illustrates an example circuit 901 that can be coupled with the configurable circuit 200, in accordance with some embodiments of the present disclosure. In some embodiments, the circuit 901 can include a D flip-flop (DFF) 905 and an adder 914. The adder 914 may be substantially similar to or incorporate features of the adder circuit 214 or an adder therein. For example, the adder 914 may be any of the 16-bit adder, 17-bit adder, 18-bit adder, 19-bit adder, 20-bit adder, 21-bit adder, or combination thereof in the adder circuit 714. The DFF 905 can be configured to store binary data during addition operation of the adder 914. In some embodiments, the DFF 905 can synchronize and store intermediate results as the data propagates through the adder 914 during the addition operations. An output of the adder 914 can be carried back to the DFF 905 through a first route 930 as an input to the DFF 905, and can be summed by the adder 914 with previously-stored data in the DFF 905. The circuit 901 can be configured to repeat (e.g., N cycles) the addition operations through the first route 930 until a predetermined condition (e.g., a cycle requirement) is met. When a cycle requirement is met, the adder 914 can provide an output through a second route 940.

FIG. 9B illustrates an example plot of signals associated with the circuit 901, in accordance with some embodiments of the present disclosure. In some embodiments, N accumulation requires N cycles. For example, 8 accumulation requires 8 cycles, 16 accumulation requires 16 cycles, 32 accumulation requires 32 cycles, and 64 accumulation requires 64 cycles. That is, for example, when the adder 914 performs the addition operation for 8 accumulation, the adder 914 and the DFF 905 can be configured to perform the addition operation through the first route 930 for 8 cycles, and then output a result of the addition operation through the second route 940, thereby calculating P0+P1+P2+P3+P4+P5+P6+P7. Likewise, when the adder 914 performs addition operation for 16 accumulation, the adder 914 and the DFF 905 can be configured to perform the addition operation through the first route 930 for 16 cycles, and then output a result of the addition operation through the second route 940, thereby calculating P0+ . . . +P14+P15. Likewise, when the adder 914 performs addition operation for 64 accumulation, the adder 914 and the DFF 905 can be configured to perform the addition operation through the first route 930 for 64 cycles, and then output a result of the addition operation through the second route 940, thereby calculating P0+ . . . +P62+P63.

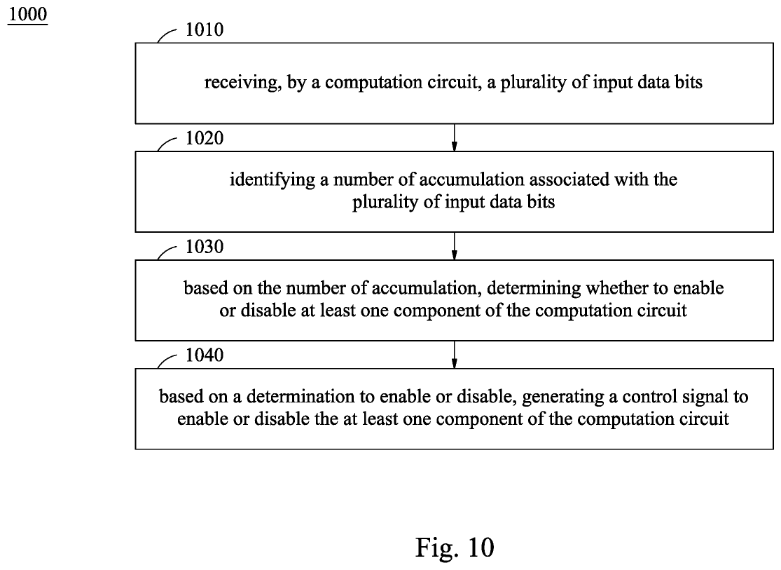

FIG. 10 illustrates a flow chart of an example method 1000 of operating a configurable circuit, in accordance with various embodiments. The example method 1000 can be performed by the circuit 200 or one or more components of the circuit 200. As such, the following embodiment of the method 1000 can be described in conjunction with but not limited to at least one of FIGS. 1-9. The illustrated embodiment of the method 1000 is provided as an example and does not limit the scope of the present disclosure. Therefore, it shall be understood that any of a variety of the operations of the method 1000 may be omitted, re-sequenced, and/or added while remaining within the scope of the present disclosure.

In a brief overview, the method 1000 can start with operation 1010 of receiving a plurality of input data bits to a computation circuit. The method 1000 can continue to operation 1020 of identifying a number of accumulation associated with the plurality of input data bits. The method 1000 can continue to operation 1030 of based on the number of accumulation, determining whether to enable or disable at least one component of the computation circuit. The method 1000 can continue to operation 1040 of based on a determination to enable or disable, generating a control signal to enable or disable the at least one component of the computation circuit.

At operation 1010, a computation circuit (e.g., the configurable circuit 200) can receive a plurality of input data bits (e.g., psums shown in FIG. 2). For example, a first component (e.g., the 19-bit adder 714D) of the computation circuit can receive 64 psums.

At operation 1020, the computation circuit can identify a number (e.g., 8A, 16A, 32A, 64A, etc.) of accumulation associated with the plurality of input data bits. In some embodiments, the computation circuit, based on the received input data bits (e.g., psums), the computation circuit can determine the addition operations to be performed (e.g., 8A, 16A, 32A, 64A, etc.). In some embodiments, the computation circuit can be configured to determine whether to perform addition operations for point wise convolution layers (e.g., a high number of accumulation, 16, 32, 64, etc.) or depth wise convolution layers (e.g., a low number of accumulation, 8, etc.).

At operation 1030, the computation circuit can determine whether to enable or disable at least one component (e.g., at least one of the N+2 bit adder 416C, the N+3 bit adder 416B, the N+4 bit adder 416A, etc.) of the computation circuit. At operation 1040, based on a determination to enable or disable, the computation circuit can generate a control signal (e.g., the signal 221) to enable or disable the at least one component of the computation circuit. For example, when the control signal indicates a first number of accumulation (e.g., 16A), the computation circuit can disable at least one component (e.g., the N+3 bit adder 416B, the N+4 bit adder 416A in FIG. 4A). For example, when the control signal indicates a second number of accumulation (e.g., 32A), the computation circuit can disable at least one component (e.g., the N+4 bit adder 416A in FIG. 4A). For example, when the control signal indicates a third number of accumulation (e.g., 64A), the computation circuit can enable at least one component (e.g., the N+2 bit adder 416C, the N+3 bit adder 416B, the N+4 bit adder 416A in FIG. 4A).

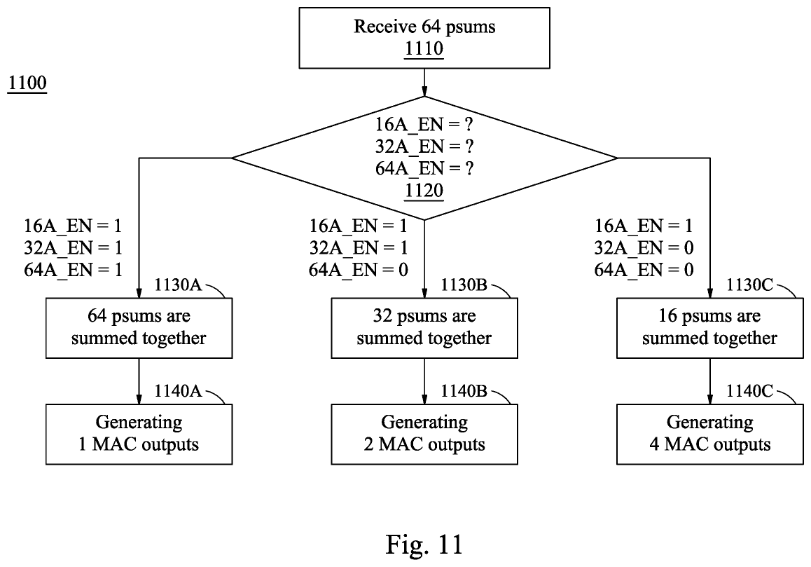

FIG. 11 illustrates a flow chart of an example method 1100 of operating a configurable circuit, in accordance with various embodiments. The example method 1100 can be performed by the circuit 200 or one or more components of the circuit 200. As such, the following embodiment of the method 1100 can be described in conjunction with but not limited to at least one of FIGS. 1-9. The illustrated embodiment of the method 1100 is provided as an example and does not limit the scope of the present disclosure. Therefore, it shall be understood that any of a variety of the operations of the method 1100 may be omitted, re-sequenced, and/or added while remaining within the scope of the present disclosure.

In a brief overview, the method 1100 can start with operation 1110 of receiving 64 psums. The method 1100 can continue to operation 1120 of identifying a number of accumulation associated with the received psums and determining a mode of accumulation. The method 1100 can continue to operation 1130 of summing the received psums. The method 1100 can continue to operation 1140 of generating an output of the MAC operations based on the summed psums.

At operation 1110, an adder circuit (e.g., the adder circuit 214) can receive the 64 psums. At operation 1120, a control circuit (e.g., the control circuit 220) can identify and determine a number of accumulation (e.g., 8A, 16A, 32A, 64A, etc.) associated with the received 64 psums. In some embodiments, the control circuit can generate a control signal that can represent four modes (e.g., shown in FIG. 6B), each of which indicates adders to be enabled/disabled. For example, when the control signal indicates 64A, the adders for 16A, 32A, and 64A can be enabled (e.g., set to “1” by 16A_EN, 32A_EN, and 64A_EN). When the control signal indicates 32A, the adders for 16A and 32A can be enabled (e.g., set to “1” by 16A_EN and 32A_EN) and the adders for 64A can be disabled (e.g., set to “0”). When the control signal indicates 16A, the adders for 16A can be enabled (e.g., set to “1” by 16A_EN) and the adders for 32A and 64A can be disabled (e.g., set to “0”).

At operation 1130A-C, the psums can be summed according to the control signal indicating the number of accumulation. When the control signal indicates 64A, the 64 psums can be summed all together, thereby generating one output of the MAC operation at operation 1140A. When the control signal indicates 32A, two sets of 32 psums can be summed together, thereby generating two outputs of the MAC operation at operation 1140B. When the control signal indicates 16A, four sets of 16 psums can be summed together, thereby generating four outputs of the MAC operation at operation 1140C. Although not shown, when the control signal indicates 8A, 8 sets of 8 psums can be summed together, thereby generating 8 outputs of the MAC operation.

In one aspect of the present disclosure, a circuit is disclosed. The system includes a computation circuit, a memory array operably coupled with the computation circuit, and a controller configured to input a plurality of input data bits to the computation circuit, identify a number of accumulation associated with the plurality of input data bits, based on the number of accumulation, determine whether to enable or disable at least one component of the computation circuit, and based on a determination to enable or disable, generate a control signal to enable or disable the at least one component of the computation circuit.

In another aspect of the present disclosure, a device is disclosed. The device includes a memory array, a computation circuit operably coupled with the memory array, the computation circuit including a first component configured to receive a plurality of input data bits and provide a first output in response to a control signal, a second component configured to receive the first output from the first component and provide a second output in response to the control signal including a first logic value, and a multiplexer configured to output the first output in response to the control signal including a second logic value, and configured to output the second output in response to the control signal including the first logic value.

In yet another aspect of the present disclosure, a method is disclosed. The method includes receiving a plurality of input data bits to a computation circuit, identifying a number of accumulation associated with the plurality of input data bits, based on the number of accumulation, determining whether to enable or disable at least one component of the computation circuit, and based on a determination to enable or disable, generating a control signal to enable or disable the at least one component of the computation circuit.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., ±10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A system, comprising:
a computation circuit;
a memory array operably coupled with the computation circuit; and
a controller configured to:
input a plurality of input data bits to the computation circuit;
identify a number of accumulation associated with the plurality of input data bits;
based on the number of accumulation, determine whether to enable or disable at least one component of the computation circuit; and
based on a determination to enable or disable, generate a control signal to enable or disable the at least one component of the computation circuit.

2. The system of claim 1, wherein the computation circuit comprises an adding component, and wherein the controller is further configured to enable or disable the adding component.

3. The system of claim 1, further comprising a multiplexer configured to:
receive a plurality of bits from a plurality of components of the computation circuit, including the at least one component; and
configure output bits, based on the number of accumulation and the plurality of bits.

4. The system of claim 3, wherein the controller is configured to set at least one bit of the output bits to a first logic state when a number of the plurality of bits from the plurality of components is smaller than a number of the output bits.

5. The system of claim 3, wherein the output bits include:
a first set of the output bits when disabling a first number of the components of the computation circuit; and
a second set of the output bits when disabling a second number of the components of the computation circuit,
wherein a number of the first set is larger than a number of the second set, and the first number is larger than the second number.

6. The system of claim 1, further comprising:
a first circuit to output a first set of bits in response to enabling the at least one component of the computation circuit; and
a second circuit to output a second set of bits in response to disabling the at least one component of the computation circuit.

7. The system of claim 1, further comprising at least one logic circuit component associated with a plurality of logic values, each of which indicates a number of the at least one component of the computation circuit to be disabled.

8. A device comprising:
a memory array;
a computation circuit operably coupled with the memory array, the computation circuit including:
a first component configured to receive a plurality of input data bits and provide a first output in response to a control signal;
a second component configured to receive the first output from the first component and provide a second output in response to the control signal including a first logic value; and
a multiplexer configured to output the first output in response to the control signal including a second logic value, and configured to output the second output in response to the control signal including the first logic value.

9. The device of claim 8, wherein at least one of the first component or the second component is an adder configured to provide an accumulation as an output.

10. The device of claim 8, wherein the second component is disabled in response to the control signal including the second logic value.

11. The device of claim 8, wherein a first bit number of the first component is smaller than a second bit number of the second component.

12. The device of claim 8, wherein the multiplexer comprises:
a first circuit to output a first set of bits in response to the control signal including the first logic value; and
a second circuit to output a second set of bits in response to the control signal including the second logic value,
wherein a first number of sets within the first set is larger than a second number of sets within the second set.

13. The device of claim 8, wherein the control signal comprises a first signal including the first logic value at a first time and a second signal including the second logic value at a second time.

14. The device of claim 8, further comprising at least one logic circuit component to generate the control signal.

15. A method, comprising:
receiving, by a computation circuit, a plurality of input data bits;
identifying a number of accumulation associated with the plurality of input data bits;
based on the number of accumulation, determining whether to enable or disable at least one component of the computation circuit; and
based on a determination to enable or disable, generating a control signal to enable or disable the at least one component of the computation circuit.

16. The method of claim 15, further comprising:
receiving, by a first component of the computation circuit, the plurality of input data bits;
providing, by the first component, a first output in response to the control signal to a second component of the computation circuit;
receiving, by the second component, the first output from the first component;
providing, by the second component, a second output in response to the control signal including a first logic value; and
outputting, by a multiplexer, the first output in response to the control signal including a second logic value, or the second output in response to the control signal including the first logic value.

17. The method of claim 16, further comprising disabling the second component in response to the control signal including the second logic value.

18. The method of claim 15, wherein the computation circuit comprises an adding component, and wherein the method further comprises enabling or disabling the adding component.

19. The method of claim 15, further comprising:
outputting a first set of bits in response to enabling the at least one component of the computation circuit; and
outputting a second set of bits in response to disabling the at least one component of the computation circuit.

20. The method of claim 15, wherein the control signal is a first control signal provided at a first time to disable a first number of the components of the computation circuit, the method further comprising:
generating a second control signal provided at a second time to disable a second number of the components of the computation circuit, the second number different from the first number.
